(19) United States
(12) Patent Application Publication
(10) Pub. No.: US 2005/0121640 A1
(43) Pub. Date: Jun. 9, 2005

(54) Flow control device for fluids

(76) Inventor: Sergio Lolli, Ascoli Piceno (IT)

Correspondence Address: Liniak Berenato & White, Suite 240, 6500 Rock Spring Drive, Bethesda, MD, 20817, US

(21) Appl. No.: 10/491,615

(22) PCT Filed: Oct. 3, 2002
(86) PCT No.: PCT/IT02/00628

(30) Foreign Application Priority Data
Oct. 5, 2001 (IT) TO2001A000947

(51) Int. Cl. F16K 1/22

(52) U.S. Cl. 251/305

(57) ABSTRACT

A flow control device (1) for fluids in which a duct (2) has a predetermined inner port (4a) controlled by a moving shutter member (3) and is provided, on each side of the moving shutter member (3), with a fixed shutter member (18) having a predetermined shape and adapted to cooperate with the moving shutter member (3) to define a hydraulic resistance varying according to a predetermined law which is a function of the shape of the fixed shutter member (18).

### TECHNICAL FIELD

The present invention relates to a flow control device for fluids.

The present invention relates more particularly to a flow control device for fluids of the type comprising a duct having a predetermined inner port and a shutter member for the port mounted to move within the duct.

### BACKGROUND ART

Control devices of the type described above, although universally used, are not normally very suited for use in cases in which it is necessary to control, with a relatively high degree of precision, the flow of fluid through the above-mentioned port when the shutter member assumes positions close to a position of total closure of the port, since relatively small displacements of the moving shutter member from its closed position generally cause relatively high variations of the flow of fluid through the port controlled by the moving shutter member.

### DISCLOSURE OF THE INVENTION

The object of the present invention is to provide a duct for the passage of fluids, which is free from the drawbacks described above and which is at the same time easy and economic to produce.

The present invention relates to a flow control device for fluids, the control device comprising a duct having a predetermined inner port, and a shutter member for the port mounted to move within the duct, characterised in that it comprises, on each side of the moving shutter member, a fixed shutter member for the port, each fixed shutter member being limited by an inner surface having a predetermined shape and the fixed shutter members being adapted to cooperate with the moving shutter member to define a hydraulic resistance varying according to a predetermined law which is a function of this shape.

### BRIEF DESCRIPTION OF THE DRAWINGS

The invention will be described below in further detail, with reference to the accompanying drawings, which show a number of non-limiting embodiments, and in which:

FIG. 1 is an axial section through a preferred embodiment of the control device of the present invention;

FIG. 2 is a cross-section along the line II-II of FIG. 1;

FIGS. 3 and 4 show, in axial section, two further embodiments of the control device of the present invention.

### BEST MODE FOR CARRYING OUT THE INVENTION

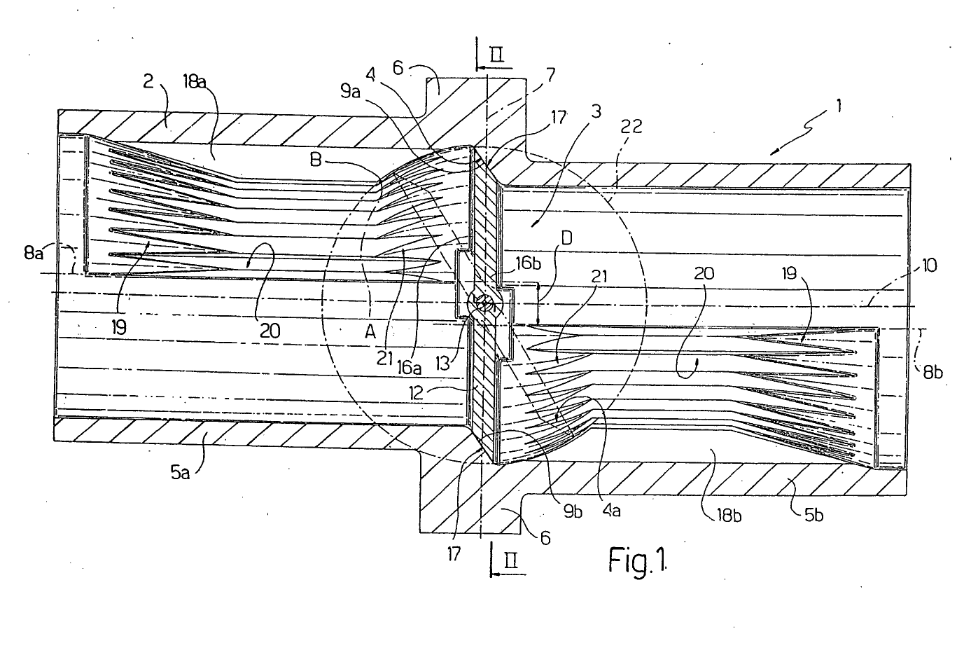

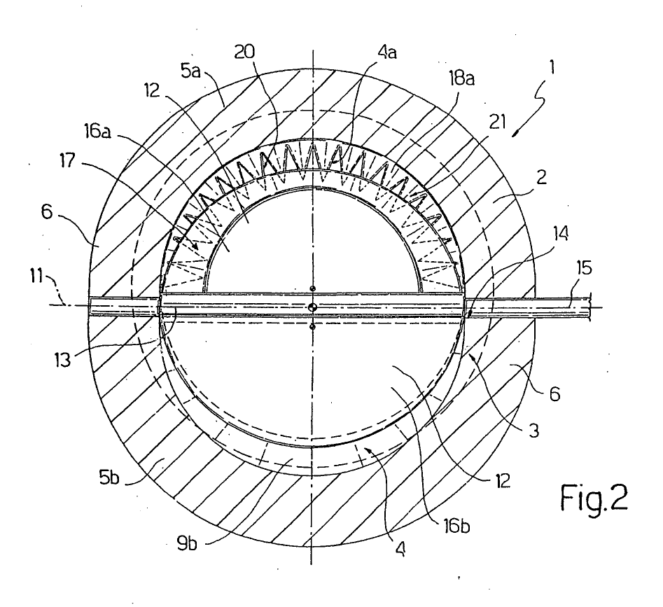

In FIGS. 1 and 2, a flow control device for fluids is shown overall by 1 and comprises a duct 2 and a moving shutter member 3 housed in the duct 2 at the location of its annular seat 4 and adapted to be displaced with respect to the seat 4 in order to vary the working flow section of a fluid through a port 4a formed by this seat 4.

The duct 2 comprises two cylindrical portions 5, shown respectively by 5a and 5b, having substantially identical inner diameters and disposed upstream and downstream respectively of the seat 4. The portions 5 are connected together at the location of respective flanges 6 in contact with one another along a transverse median plane 7 of the seat 4 and have respective longitudinal axes 8a and 8b which are parallel to one another and perpendicular to the transverse median plane 7, both lie in the plane of FIG. 1 and are disposed at a predetermined distance D from one another with the longitudinal axis 8a disposed, in FIG. 1, above the longitudinal axis 8b. Following the offset position of the two portions 5, the union between these two portions 5 at the location of the transverse median plane 7 defines two shoulders 9, shown respectively by 9a and 9b, of half-moon shape, respectively facing the portion 5a and the portion 5b, which are subsequently made frustoconical, with opposing conicity, by means of internal working and overall form the seat 4. Each shoulder 9 has two opposite ends, at which the width of the shoulder 9 is reduced to zero, disposed on a same longitudinal median plane 10 extending longitudinally along the entire duct 2, perpendicular to the plane of FIG. 1 and equidistant from the longitudinal axes Ba and 8b.

The intersection between the planes 7 and 10 defines the axis of rotation 11 of a butterfly shutter 12 forming part of the shutter member 3, which further comprises a pin 13 rigid with the butterfly shutter 12 and coaxial with the axis of rotation 11. The pin 13 comprises two portions mounted idly through respective substantially radial holes 14 obtained through the wall of the duct 2 coaxially with the axis of rotation 11 and a control portion 15 disposed externally to the duct 2. The butterfly shutter 12 comprises two flanges 16, shown respectively by 16a and 16b, which are substantially cylindrical, intersect with one another along a plane passing through the axis of rotation 11, and have respective parallel axes which are disposed coaxially with the longitudinal axes 8a and 8b respectively when the butterfly shutter 12 is in a position parallel to the transverse median plane 7 and closing the port 4a (shown in continuous lines in FIG. 1).

Part of the outer lateral surface of each flange 16 is defined by a frustoconical surface 17 which is complementary with the frustoconical surface of the relative shoulder 9 and is coupled in a leak-tight manner with the relative shoulder 9 when the butterfly shutter 12 is in its closed position.

The device 1 further comprises two fixed shutter members 18, shown respectively by 18a and 18b, which cooperate with the butterfly shutter 12 in order to close off the port 4a and are respectively disposed within the portions 5a and 5b and on opposite sides of the longitudinal median plane 10. Each fixed shutter member 18 forms a single piece with the respective portion 5.

Each fixed shutter member 18 has a semi-cylindrical inner surface 19 which is concave and coaxial with the respective longitudinal axis 8 and which is traversed by a plurality of axial grooves 20 of substantially triangular section with their vertices facing the exterior of the duct 2, and is limited, on the side facing the butterfly shutter 12, by a concave end surface 21 which intersects the grooves 20. Each concave end surface 21 has a shape substantially complementary with a respective part of a convex surface 22 of a rotational solid generated by the rotation of the butterfly shutter 12 about the axis of rotation 11. In particular, the points A of the convex surface 22 arranged along a same generatrix of this convex surface 22 are disposed at a relatively small and constant distance from respective corresponding points B of the concave end surface 21.

In operation, during a first part of the rotation of the butterfly shutter 12 about the axis of rotation 11 from its rest position in contact with the seat 4, the outer profile of each flange 16 is maintained at a substantially constant and relatively small (normally of the order of some tenths of a millimetre) distance from the relative end surface 21 allowing the passage, through the port 4a, substantially only of the fluid passing through that part of each end section of each groove 20 which is gradually exposed by the butterfly shutter 12. Since the section of each groove 20 is triangular with its vertex facing outwards, the free port through which the fluid may flow increases in a relatively modest way with the variation of the angle of opening of the butterfly shutter 12 when the outer profile of each flange 16 of the butterfly shutter 12 remains facing the relative end surface 21 allowing the control device 1 to control, with relatively high precision, the flow of fluid through the port 4a at relatively small opening angles from the above-mentioned closed position.

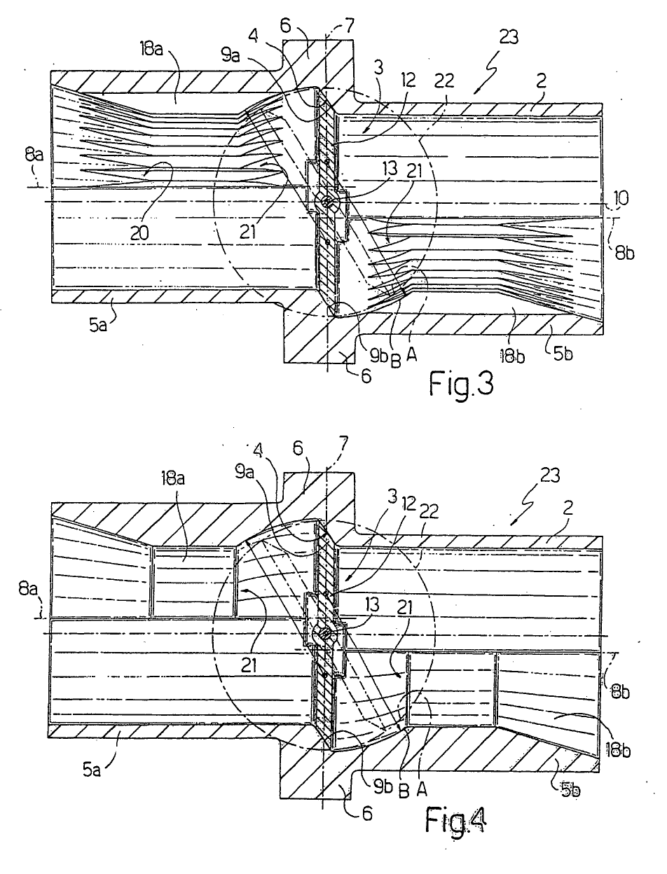

The variant shown in FIG. 3 relates to a control device 23 similar to the control device 1, whose members bear the same reference numerals as corresponding members of the control device 1.

The control device 23 differs from the control device 1 substantially only in that, in the control device 23, each end surface 21 is shaped as a parabolic or elliptical crown such that the points A arranged along a same generatrix of the convex surface 22 are disposed, with respect to the corresponding points B of the end surface 21, at distances that are relatively small but that grow as the distance of the points A from the transverse median plane 7 increases.

The variant shown in FIG. 4 is completely identical to the variant shown in FIG. 3, from which it differs only in that, in the variant of FIG. 4, the grooves 20 are omitted.

According to a variant which is not shown, each fixed shutter member 18 does not form a single piece with the respective portion 5, but is disposed within the respective portion 5 and in contact with an inner surface of this respective portion 5.

1. A flow control device for fluids, the control device (1) comprising a duct (2) having a predetermined inner port (4a), and a shutter member (3) for the port mounted to move within the duct (2), characterised in that it comprises, on each side of the moving shutter member (3), a fixed shutter member (18) for the port, each fixed shutter member (18) being limited by an inner surface (19) having a predetermined shape and the fixed shutter members (18) being adapted to cooperate with the moving shutter member (3) to define a hydraulic resistance varying according to a predetermined law which is a function of this shape.

2. A device as claimed in claim 1, in which the moving shutter member (3) comprises a butterfly shutter (12) mounted to rotate within the duct (2) and about its own axis of rotation (12) transverse to the duct (2).

3. A device as claimed in claim 2, in which the butterfly shutter (12) defines, by rotating about the axis of rotation (11), a rotational solid having a predetermined outer convex surface (22), the inner surface (19) of each fixed shutter member (18) being a surface grooved by means of a plurality of grooves (20) extending longitudinally with respect to the duct (2) and limited, on the side facing the butterfly shutter (12), by a concave end surface (21) substantially complementary with at least part of the convex surface (22), the grooves (20) terminating, on the side facing the butterfly shutter (12), at the concave end surface (21), and each groove (20) having a width variable in a radial direction with respect to the duct (2).

4. A device as claimed in claim 3, in which the grooves (20) have a substantially triangular shape in cross-section with their vertices facing outwards.

5. A device as claimed in claim 3, in which the convex surface (22) has first points (A) arranged along a same generatrix, disposed at respective predetermined distances from corresponding second points (B) of the concave end surface (21), these distances being equal to one another.

6. A device as claimed in claim 3, in which the convex surface (22) has first points (A) arranged along a same generatrix, disposed at respective predetermined distances from corresponding second points (B) of the concave end surface (21), each distance being a function of a distance of each first point (A) from a median plane (7) transverse to the duct (2) and passing through the axis of rotation (11).

7. A device as claimed in claim 2, in which the butterfly shutter (12) defines, by rotating about its axis of rotation (11), a rotational solid having a predetermined outer convex surface (22), the inner surface (19) of each fixed shutter member (18) being a surface limited, on the side facing the butterfly shutter (12), by a concave end surface (21) substantially complementary with at least part of the convex surface (22), the convex surface (22) having first points (A), arranged along a same generatrix, disposed at respective distances determined by corresponding second points (B) of the concave end surface (21) and each distance being a function of a distance of each first point (A) from a median plane (7) transverse to the duct (2) and passing through the axis of rotation (11).

8. A device as claimed in claim 2, in which the two fixed shutter members (18) are disposed on opposite sides of a plane passing through the axis of rotation (11) and parallel to the duct (2).

9. A device as claimed in claim 2, in which the duct (2) comprises a first and a second cylindrical portion (5a, 5b) disposed on opposite sides of the butterfly shutter (12) and parallel and offset with respect to one another, the two cylindrical portions (5a, 5b) being connected together at the location of a median plane (7) transverse to the duct (2) and passing through the axis of rotation (11) and defining, on the transverse median plane (7), two half-moon shoulders (9) facing in opposite directions and disposed on opposite sides of a longitudinal median plane (10) passing through the axis of rotation (11), the two shoulders (9) defining a seat (4) for abutment of the butterfly shutter (12) in its position closing the port (4a).

10. A device as claimed in claim 9, in which the butterfly shutter (12) is defined by two substantially circular flanges (16a, 16b) intersecting one another along the axis of rotation (11) and each disposed coaxially with a respective cylindrical portion (5a, 5b) when the butterfly shutter (12) is disposed in the closed position.

11. A device as claimed in claim 10, in which each shoulder (9) is defined by a section of conical surface, each flange (16) having an external frustoconical profile complementary with the section of conical surface of the relative shoulder (9).
